(19) United States
(12) Patent Application Publication
(10) Pub. No.: US 2025/0237792 A1
(43) Pub. Date: Jul. 24, 2025

(54) BACK REFLECTION REDUCTION IN AUGMENTED REALITY NEAR-EYE DEVICES BASED ON A NANOIMPRINTING PROCESS

(71) Applicant: GOOGLE LLC, Mountain View, CA (US)

(72) Inventor: Qinglan Huang, Mountain View, CA (US)

(21) Appl. No.: 18/416,176

(22) Filed: Jan. 18, 2024

(51) Int. Cl. G02B 1/118

(52) U.S. Cl. CPC G02B 1/118

(57) ABSTRACT

A method of reducing the back reflection at a resin blanket area of augmented reality glasses through inkjet-based nanoimprinting includes forming a first layer on a substrate, the first layer includes a high refractive index material. A pattern is nanoimprinted in the first layer by applying a first nanoimprint mold to the first layer. The pattern includes one or more grating regions and one or more blanketing regions. An inkjet deposition process is performed to form a second layer only on the blanketing regions of the pattern. The second layer includes a low refractive index material. A uniform low refractive index thin film is nanoimprinted by applying a second nanoimprint mold to the second layer.

### BACKGROUND

Augmented Reality (AR) near-eye devices, such as AR glasses, are a technology that overlays digital content onto the real world. AR near-eye devices differ from Virtual Reality (VR) near-eye devices, which create a fully artificial environment, by integrating digital elements into the user's physical surroundings. Initially, AR technology was limited to desktop computers and lacked portability. Modern AR near-eye devices, however, are more user-friendly, often being lightweight and equipped with features such as voice recognition and gesture control. These advancements have made AR near-eye devices more practical for everyday use.

### SUMMARY OF EMBODIMENTS

In accordance with one aspect, a method includes forming a first layer on a substrate, the first layer comprising a high refractive index material. A pattern is formed in the first layer includes one or more grating regions and one or more blanketing regions. A second layer is formed only on the one or more blanketing regions, the second layer comprising a low refractive index material.

In accordance with another aspect, a method includes forming a first layer on a substrate. The first layer includes a high refractive index material. A pattern is nanoimprinted in the first layer by applying a first nanoimprint mold to the first layer. The pattern includes one or more grating regions and one or more blanketing regions. An inkjet deposition process is performed to form a second layer only on the blanketing regions of the pattern. The second layer includes a low refractive index material. A uniform low refractive index thin film is nanoimprinted by applying a second nanoimprint mold to the second layer.

In accordance with a further aspect, an optical structure includes a first layer on a glass substrate. The first layer includes a high refractive index resin-based material. The optical structure further includes a pattern formed in the first layer. The pattern includes one or more grating regions and one or more blanketing regions. A second layer is formed only on the blanketing regions. The second layer is an antireflection layer including a resin-based uniform low refractive index thin film.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a cross-sectional view of a substrate in accordance with some embodiments.

FIG. 2 is a cross-sectional view of a structure including the substrate of FIG. 1 after a high refractive index layer has been formed thereon in accordance with some embodiments.

FIG. 3 is a cross-sectional view of the structure of FIG. 2 having a nanoimprint mold disposed above the high refractive index layer in accordance with some embodiments.

FIG. 4 is a cross-sectional view of the structure of FIG. 3 after the nanoimprint mold has been pressed into the high refractive index layer in accordance with some embodiments.

FIG. 5 is a cross-sectional view of the structure of FIG. 4 after the nanoimprint mold has been separated from the high refractive index layer in accordance with some embodiments.

FIG. 6 is a cross-sectional view of the structure of FIG. 5 after an inkjet deposition process has been performed to form a low refractive index layer on blanketing regions of the high refractive index layer in accordance with some embodiments.

FIG. 7 is a cross-sectional view of the structure of FIG. 6 during a nanoimprint process where a nanoimprint mold has been pressed onto the low refractive index layer to form a unform antireflection layer/coating on the blanket regions in accordance with some embodiments.

FIG. 8 is a cross-sectional view of the structure of FIG. 7 after the nanoimprint mold has been separated from the unform antireflection layer in accordance with some embodiments.

FIG. 9 is a flow diagram illustrating an example method for reducing the back reflection at a resin blanket area of AR glass through inkjet-based nanoimprinting in accordance with at least some embodiments.

### DETAILED DESCRIPTION

The advent and evolution of Augmented Reality (AR) technology have brought forth a new era in digital interaction and visualization. AR near-eye devices, a prime example of this technological advancement, are at the forefront of integrating digital information seamlessly into the user's physical environment. AR near-eye devices represent a significant leap from traditional display technologies, offering a more interactive and immersive experience.

A fundamental component in the design of AR near-eye devices is a glass substrate, which forms the base upon which other critical elements are built. The substrate is crucial for ensuring structural integrity and optical clarity. Typically a resin layer overlays the glass substrate. The choice of resin is important to the functionality of the AR near-eye devices. A high refractive index, typically above 1.8, is a critical property of the resin used. This high refractive index helps achieve optimal waveguide efficiency. Waveguides in AR near-eye devices are responsible for directing light from the display source to the user's eyes, creating the illusion that digital images are part of the physical world. The efficiency of this process greatly influences the quality and clarity of the augmented reality experience.

Embedded within the resin are grating structures, intricately formed through a process known as nanoimprint lithography. Nanoimprinting allows for the precise and miniature patterning necessary in the waveguide design. The grating structures play a crucial role in controlling the direction and dispersion of light within the AR near-eye devices, thereby enabling the accurate projection of images and information in the user's field of view. The combination of the glass substrate, the high-index resin, and the nanoimprinted grating structures constitutes the core of AR near-eye devices' optical system. The optical system is the cornerstone upon which AR near-eye devices are able to merge digital content with the physical world, providing users with an unprecedented level of interaction and immersion in augmented reality environments.

A significant technical hurdle in the design of AR near-eye devices is managing back reflection. This issue stems primarily from the high refractive index of the resin used on the glass substrates implemented in the AR near-eye devices. The resin's refractive index, which is essential for optimal waveguide efficiency, unfortunately also results in substantial light reflection at the interface between the air and the resin. This reflection, typically around 10% or more, creates visual disturbances in the form of ghosts or see-through artifacts. The artifacts detract from the overall user experience by reducing the clarity and integrity of the augmented imagery.

The problem of back reflection is most evident in the blanket (non-grating) regions of the substrate, which lack the grating structures. In other optical applications, such as in the semiconductor industry, surface reflection is typically reduced using an anti-reflection coating. This coating often includes of a multilayer dielectric thin film applied directly to the surface in question. While effective in other contexts, this approach poses compatibility issues with the resin nanoimprint process used in AR near-eye devices. The nanoimprint process, crucial for creating the fine grating structures in the resin, can be adversely affected by the application of standard anti-reflection coatings.

Additionally, the selective application of anti-reflective thin film coating poses its own set of challenges. Coating the blanket region without affecting the grating areas requires precise control and alignment. Stated differently, masking out the grating region and only depositing thin film on the blanket resin region after the gratings are fabricated is difficult and costly in a production environment. This level of precision is necessary to ensure that the coating does not interfere with the light manipulation functions of the grating structures, which are essential for the AR near-eye devices to function correctly.

As such, the following describes embodiments of systems and methods for reducing the back reflection at the resin blanket area of AR glass through inkjet-based nanoimprinting. As described in greater detail below, a first layer of high refractive index resin is spin coated onto a glass substrate. A nanoimprinting process is then performed to form a grating structure in the first layer. For example, a grating region and a non-grating blanket region are formed within the first layer. A second layer of low refractive index resin is selectively formed or dispensed only on the non-grating region, while keeping the grating region intact, using, for example, an inkjet printing process. The second layer is then cured using, for example, ultraviolet (UV light) and functions as an efficient anti-reflection layer. As such, the inkjet-based nanoimprinting techniques described herein form a uniform low-index thin film on top of the high index resin blanket (non-grating) region of the glass substrate to function as efficient anti-reflection layer while avoiding the issues typically encountered with semiconductor-standard processes.

Note that in the following, certain orientational terms, such as top, bottom, front, back, and the like, are used in a relative sense to describe the positional relationship of various components. These terms are used with reference to the relative position of components either as shown in the corresponding figure or as used by convention in the art and are not intended to be interpreted in an absolute sense with reference to a field of gravity. Thus, for example, a surface shown in the drawing and referred to as a top surface of a component would still be properly understood as being the top surface of the component, even if, in implementation, the component was placed in an inverted position with respect to the position shown in the corresponding figure and described in this disclosure. Further, note that certain positional terms, such as co-planar or parallel, will be understood to be interpreted in the context of fabrication tolerances or industry standards. For example, co-planar shall be understood to mean co-planar within applicable tolerances as a result of one or more fabrication processes affecting the components indicated to be co-planar, or co-planar within a tolerance utilized in the appropriate industry or fabrication technology. Moreover, it will be appreciated that for simplicity and clarity of illustration, components shown in the figures have not necessarily been drawn to scale. For example, the dimensions of some of the components may be exaggerated relative to other components.

It also should be noted that the terms “contact”, “contacts”, “contacting”, or their equivalents refer to, for example, components, such as layers, features, or surfaces being in physical (direct) contact or indirect contact through one or more intermediate layers, features, or surfaces, or the like. Moreover, a component can be in “electrical contact” with one or more other components, either directly or indirectly through one or more intermediate components, depending on the electrical conductivity of the components' material(s).

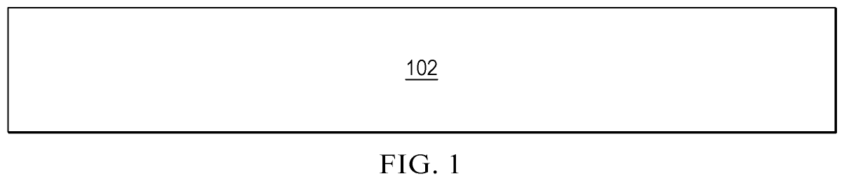

FIG. 1 to FIG. 8 illustrate various processes for reducing the back reflection at a resin blanket area of AR glass through inkjet-based nanoimprinting in accordance with at least some embodiments. In general, the figures comprise various cross-sectional views that are taken along a line that passes across the illustrated structures and layers. FIG. 1 shows a substrate 102 for an optical system, such as an AR near-eye device. In at least some embodiments, the substrate 102 is comprised of glass (e.g., amorphous solid materials such as silicates, borates, phosphates, a combination thereof, or the like), polymers, plastics, silicon, quarts, sapphire, composite materials, a combination thereof, or the like.

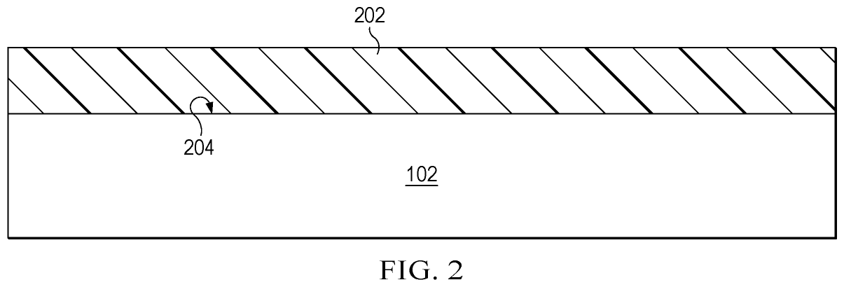

In at least some embodiments, the substrate 102 is prepared (e.g., cleaned) and a first layer 202 is formed over a surface 204 of the substrate 102, as shown in FIG. 2. In at least some embodiments, the surface 204 is a top surface of the substrate 102 when oriented as shown in FIG. 2. The first layer 202, in at least some embodiments, is formed on and in contact with the surface 204. In at least some embodiments, the first layer 202 is comprised of a material, such as resin, that is formed or deposited over the surface 204 using a process such as spin coating, dip coating, spray coating, or the like. The resin, in at least some implementations, is a high refractive index resin having a refractive index of at least 1.8, although other indices (e.g., a refractive index of 1.5) are applicable as well. Examples of a high refractive index resin include epoxy-based resins, acrylic resins, thiol-ene based resins, nanocomposite resins, urethane acrylate resins, or the like.

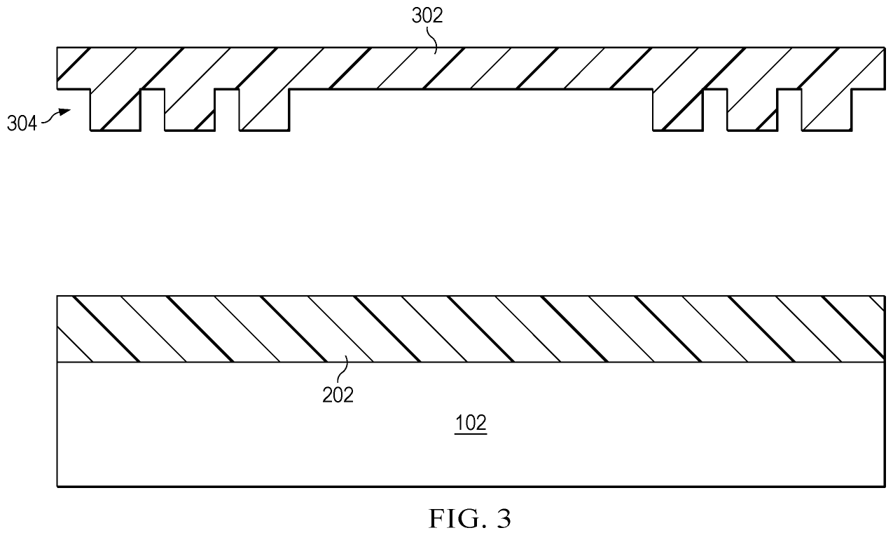

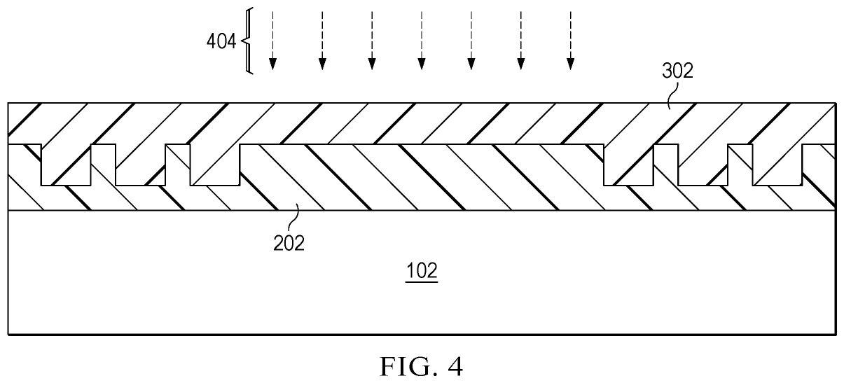

After the first layer 202 has been formed, a pattern is formed in the first layer 202. For example, in at least some embodiments, the first layer 202 is heated above its glass transition temperature to make the first layer 202 pliable. In other embodiments, the first layer 202 is not subjected to heat until at this stage (or at all). A nanoimprinting mold 302, which has the inverse pattern 304 of a desired grating pattern to be formed in the first layer 202, is positioned over the first layer 202, as shown in FIG. 3. A nanoimprinting process is then performed by pressing the mold 302 into the first layer 202, as shown in FIG. 4. In at least some embodiments, the substrate 102 and first layer 202 are baked while the mold 302 is pressed into the first layer 202. The first layer 202 is then cured using, for example, UV light 404. In other embodiments, the first layer 202 is allowed to cool for a period of time. The curing/cooling process sets the pattern 304 into the first layer 202.

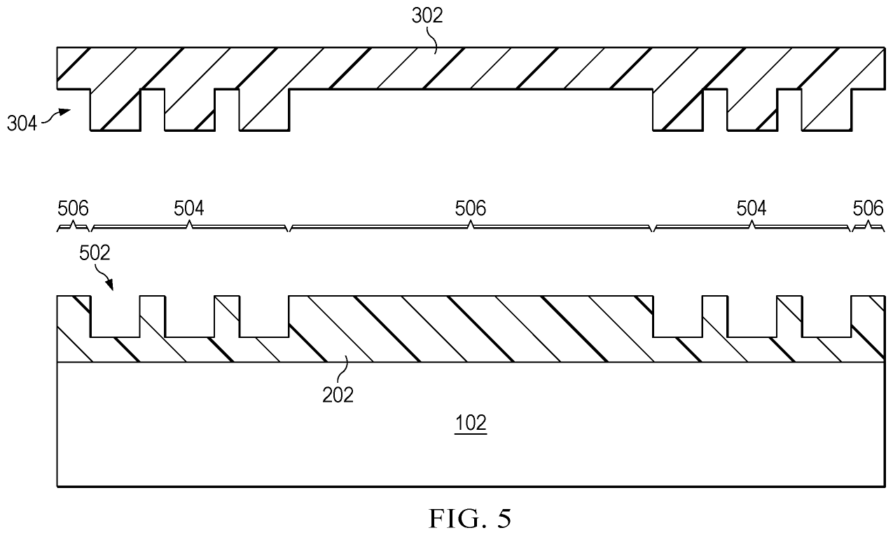

After the first layer 202 has cured or cooled, a demolding process is performed to separate/remove the nanoimprinting mold 302 from the first layer 202, as shown in FIG. 5. The result of the nanoimprinting process is a pattern 502, which corresponds to the inverse pattern 304 of the nanoimprinting mold 302, that is formed in the first layer 202. The pattern 502 includes a high refractive index grating region 504 (herein referred to as the “grating region 504:”) and a high refractive index non-grating blanket region 506 (herein referred to as the “blanket region 506”). The grating region 504 includes actual the grating pattern, which is comprised of a series of lines or grooves with specific dimensions (pitch, depth, and profile shape). The blanket region 506 is devoid of any grating pattern (e.g., a smooth, uninterrupted area). The absence of structured features means that the blanket region 506 does not interact with light in the same way as the grating region 504.

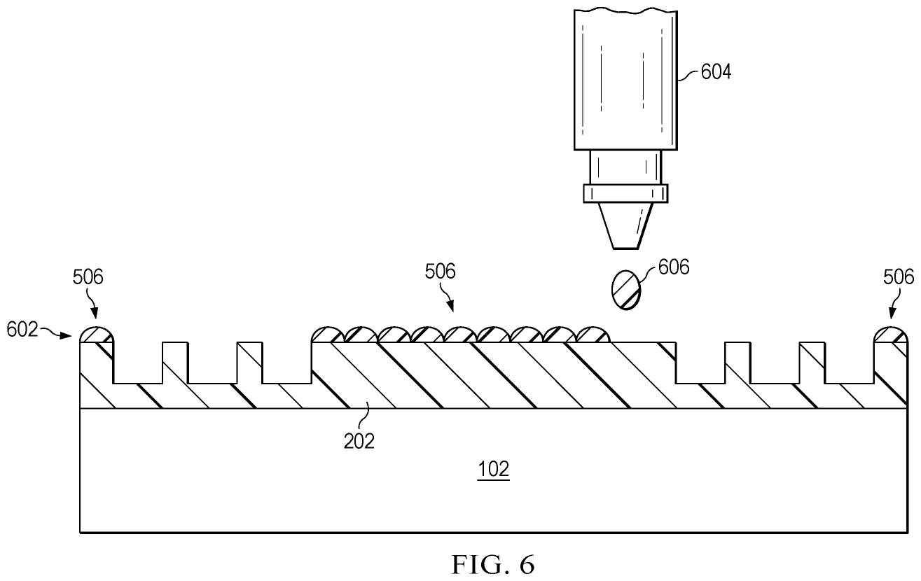

After the nanoimprinting mold 302 has been separated from the first layer 202, a second layer 602 is formed over the first layer 202, as shown in FIG. 6. The second layer 602, in at least some embodiments, contacts the first layer 202. In at least some embodiments, the second layer 602 is selectively deposited or formed only on and in contact with the blanket region 506 of the first layer 202. The second layer 602, in at least some embodiments, is comprised of a material, such as resin, having a low refractive index of less than 1.8, although other indices are applicable as well. Examples of a low refractive index resin include fluoropolymer-based resins, siloxane-based resins, perfluorinated polymers, acrylic resins, or the like.

In at least some embodiments, an inkjet deposition process is used to selectively deposit material forming the second layer 602 on the blanket region 506. The inkjet deposition process is a digital, non-contact printing method that allows for precise placement of material with high resolution. In at least some embodiments, a digital design of the pattern to be printed is created. This design dictates where the printer deposits the resin on the first layer 202. The printer head 604 moves over the first layer 202 and ejects droplets 606 of resin from the nozzles onto specific locations of the first layer 202, such as the blanket regions 506 of the pattern 502 formed in the first layer 202. The droplets 606 are typically in the picoliter range, allowing for fine resolution. However, other sized droplets are applicable as well. The material is deposited layer by layer, with each layer, in at least some embodiments, being cured or solidified before the next one is applied.

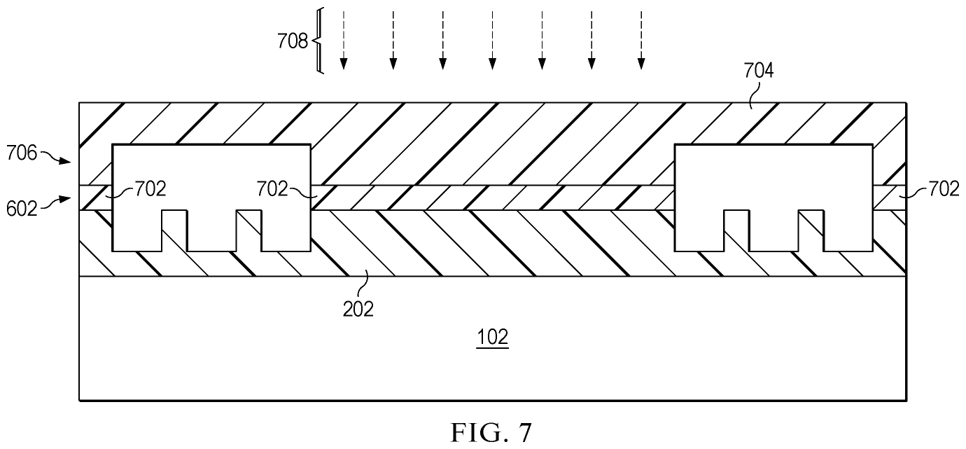

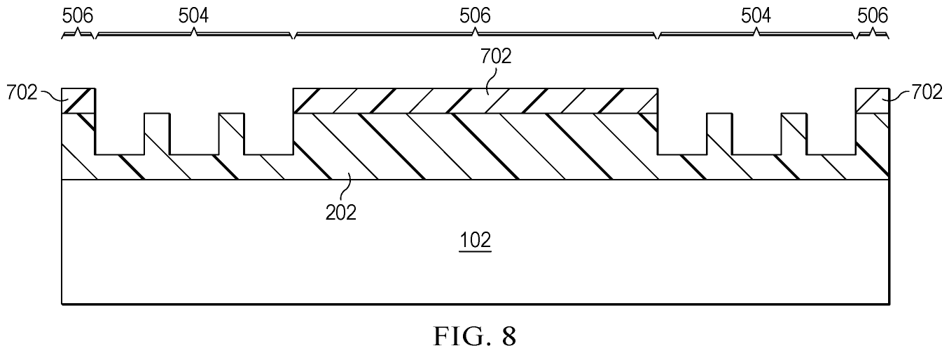

After the second layer 202 has been formed, the second layer 202 is patterned to form a uniform low refractive index thin film on top of the high index resin blanket region 506, as shown in FIG. 7 and FIG. 8. In at least some embodiments, a nanoimprinting process is performed to form the uniform low refractive index thin film 702. For example, the second layer 602 is heated above its glass transition temperature to make the second layer 602 pliable. In other embodiments, the second layer 602 is not subjected to heat at this stage (or at all). Another nanoimprinting mold 704, which has a pattern 706 to form the uniform low refractive index thin film 702 from the second layer 602, is positioned over and pressed into the second layer 602, as shown in FIG. 7. In at least some embodiments, the structure is baked while the mold 704 is pressed into the second layer 602. In other embodiments, the baking process is not performed. The second layer 602 is then cured using, for example, UV light 708. In other embodiments, the uniform low refractive index thin film 702 is allowed to cool for a period of time. The curing/cooling process sets the pattern 706 into the second layer 602 to form the uniform low refractive index thin film 702.

After the second layer 602 has cured or cooled, a demolding process is performed to separate/remove the nanoimprinting mold 704 from the second layer 602, as shown in FIG. 8. The result of this nanoimprinting process is a uniform low refractive index thin film/layer 702 formed on a surface of the high refractive index blanket regions 506 of the first layer 202. As shown, in FIG. 8, the uniform low refractive index thin film 702 is not form on the grating regions 504 of the first layer. The uniform low refractive index thin film 702 functions as an efficient antireflection layer to suppress the reflection at the resin/air interface. For example, the optical structure shown in FIG. 8 including the uniform low refractive index thin film 702 results in at least a 1 order of magnitude reduction in reflection when compared to a similar optical structure without the uniform low refractive index thin film 702.

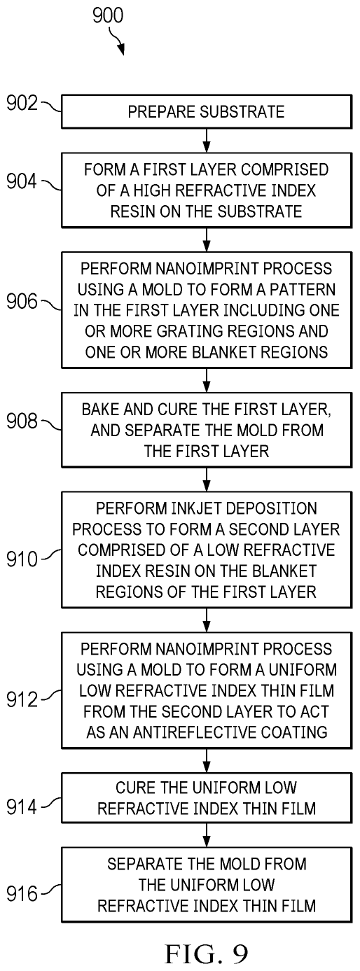

FIG. 9 is a diagram illustrating an example method 900 of reducing the back reflection at a resin blanket area of AR glass through inkjet-based nanoimprinting in accordance with at least some embodiments. It should be understood that the processes described below with respect to method 900 have been described above in greater detail with reference to FIG. 1 to FIG. 8. The method 900 is not limited to the sequence of operations shown in FIG. 9, as at least some of the operations can be performed in parallel or in a different sequence. Moreover, in at least some implementations, the method 900 can include one or more different operations than those shown in FIG. 9.

At block 902 a substrate 102 comprised, for example, glass material, is prepared. At block 904, a first layer 202 comprised of a high refractive index resin-based material is formed on the a surface 204 of the substrate 102 using, for example, a spin coating process. At block 906, a nanoimprinting process is performed using a mold 302 to form a pattern 502 in the first layer 202. The pattern 502 includes one or more grating regions 504 and one or more blanket regions 506. At block 908, the first layer 202 is cured using, for example, UV light 404 and the mold 302 is separated from the first layer 202. At block 910, an inkjet deposition process is performed to selectively form a second layer 602 comprised of a low refractive index resin-based material only on the blanket regions 506 of the first layer 202. At block 912, a nanoimprinting process is performed using a mold 704 to form a uniform low refractive index thin film/layer 702 from the second layer 602 formed on the blanket regions 506 of the first layer 202. At block 914, the uniform low refractive index thin film 702 is cured using, for example, UV light 708. At block 916, the mold 704 is separated from the uniform low refractive index thin film/layer 702.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
forming a first layer on a glass substrate, the first layer comprising a high refractive index material;
forming a pattern in the first layer comprising one or more grating regions and one or more blanketing regions; and
forming a second layer only on the one or more blanketing regions, the second layer comprising a low refractive index material.

2. The method of claim 1, wherein forming the first layer comprises:
spin coating the high refractive index material onto the glass substrate.

3. The method of claim 1, wherein forming the pattern in the first layer comprises:
nanoimprinting the pattern into the first layer using a nanoimprint mold.

4. The method of claim 1, wherein forming the pattern in the first layer further comprises:
after the pattern has been nanoimprinted into the first layer, curing the first layer.

5. The method of claim 1, wherein forming the second layer comprises:
inkjet depositing the low refractive index material only onto the one or more blanket regions of the first layer.

6. The method of claim 1, further comprising:
forming a uniform low refractive index thin film from the second layer.

7. The method of claim 6, wherein forming the uniform low refractive index thin film comprises:
nanoimprinting the uniform low refractive index thin film by applying a nanoimprint mold to the second layer.

8. A method comprising:
forming a first layer on a substrate, the first layer comprising a high refractive index material;
nanoimprinting a pattern in the first layer by applying a first nanoimprint mold to the first layer, the pattern comprising one or more grating regions and one or more blanketing regions;
performing an inkjet deposition process to form a second layer only on the blanketing regions of the pattern, the second layer comprising a low refractive index material; and
nanoimprinting a uniform low refractive index thin film by applying a second nanoimprint mold to the second layer.

9. The method of claim 8, further comprising:
after applying the first nanoimprint mold to the first layer, curing the first layer; and
after applying the second nanoimprint mold to the second layer, curing the uniform low refractive index thin film.

10. An optical structure comprising:
a first layer on a glass substrate, the first layer comprising a high refractive index resin-based material;
a pattern formed in the first layer and comprising one or more grating regions and one or more blanketing regions; and
a second layer formed only on the blanketing regions, wherein the second layer is an antireflection layer comprising a resin-based uniform low refractive index thin film.
